(19) United States
(12) Patent Application Publication
(10) Pub. No.: US 2007/0284030 A1
(43) Pub. Date: Dec. 13, 2007

(54) Seat pad and method for making the same

(76) Inventor: Ching-Song Lee, Nantou City (TW)

Correspondence Address: JACOBSON HOLMAN PLLC, 400 SEVENTH STREET, N.W., WASHINGTON, DC, 20004, US

(21) Appl. No.: 11/448,776

(22) Filed: Jun. 8, 2006

(51) Int. Cl. B32B 27/00

(52) U.S. Cl. 156/242; 297/219.1

(57) ABSTRACT

A method for making a seat pad includes the steps of: providing a mold having a mold cavity; disposing a first leather sheet in the mold cavity in the mold; filling a thermoplastic resin material into the mold cavity; curing the thermoplastic resin material and molding an assembly of the thermoplastic resin material and the first leather sheet so as to form the thermoplastic resin material into a rigid resin layer bonded to the first leather sheet; removing the assembly of the rigid resin layer and the first leather sheet from the mold; and adhering a second leather sheet to one side of the first leather sheet opposite to the rigid resin layer. A seat pad includes a first leather sheet; a second leather sheet adhered to the first leather sheet; and a rigid resin layer of a thermoplastic material bonded to the first leather sheet.

### BACKGROUND OF THE INVENTION

1. Field of the Invention

This invention relates to a seat pad and a method for making the same.

2. Description of the Related Art

A conventional leather seat pad is usually produced by laminating multiple leather sheets into a laminated structure, and molding the laminated structure into a desired seat shape. However, because of difficulty in shaping leather, a complicated process for shaping the laminated structure is needed. Alternatively, the laminated structure can be bonded to a resilient support unit to form a seat pad with a desired shape. Because of poor adhesion between leather and other materials, connection between the two materials remains a problem that has to be improved.

### SUMMARY OF THE INVENTION

Therefore, the object of the present invention is to provide a seat pad and a method for making the same that can overcome the aforesaid drawback associated with the prior art.

According to one aspect of this invention, a method for making a seat pad comprises the steps of: providing a mold having a mold cavity; disposing a first leather sheet in the mold cavity in the mold; filling a thermoplastic resin material into the mold cavity; curing the thermoplastic resin material and molding an assembly of the thermoplastic resin material and the first leather sheet so as to form the thermoplastic resin material into a rigid resin layer bonded to the first leather sheet; removing the assembly of the rigid resin layer and the first leather sheet from the mold; and adhering a second leather sheet to one side of the first leather sheet opposite to the rigid resin layer.

According to another aspect of this invention, a seat pad comprises: a first leather sheet having upper and lower surfaces; a second leather sheet adhered to the upper surface of the first leather sheet; and a rigid resin layer of a thermoplastic material bonded to the lower surface of the first leather sheet.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic partly cutaway view of the preferred embodiment of a seat pad according to this invention;

FIG. 2 is a flow chart illustrating consecutive steps of the preferred embodiment of a method for producing a seat pad according to this invention;

FIG. 3 is a schematic cross-sectional view illustrating the step of forming an assembly of the thermoplastic resin material and the first leather sheet; and

FIG. 4 is a sectional view of the seat pad shown in FIG. 1.

### DETAILED DESCRIPTION OF THE PREFERRED EMBODIMENTS

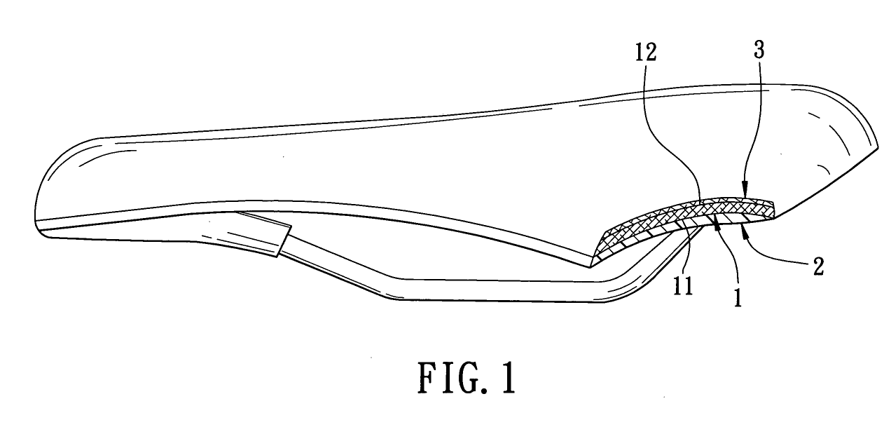

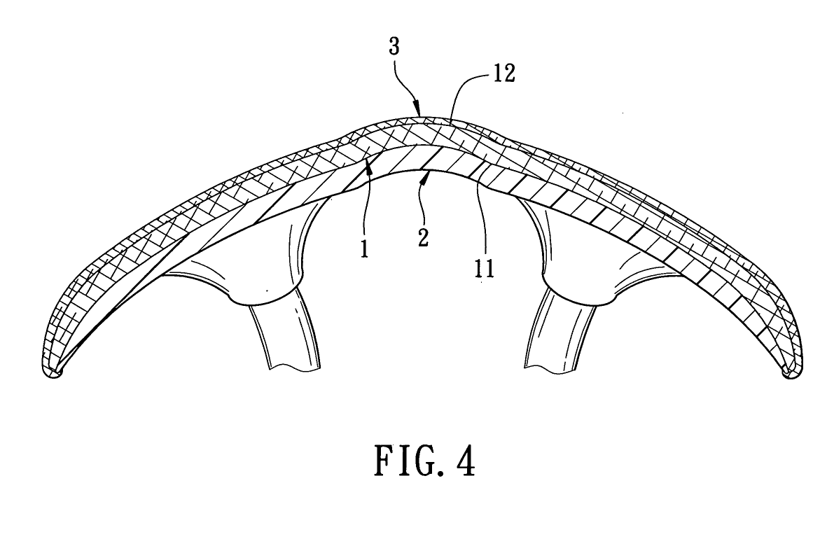

Referring to FIGS. 1 and 4, the preferred embodiment of a seat pad according to the present invention is shown to include a first leather sheet 1 having an upper surface 12 and a lower surface 11; a second leather sheet 3 adhered to the upper surface 12 of the first leather sheet 1; and a rigid resin layer 2 of a thermoplastic material bonded to the lower surface 11 of the first leather sheet 1.

Preferably, the rigid resin layer 2 of thermoplastic material is made from polyurethane (PU).

Preferably, the second leather sheet 3 has superior quality over the first leather sheet 1 so that the seat pad thus made has good appearance while minimizing costs.

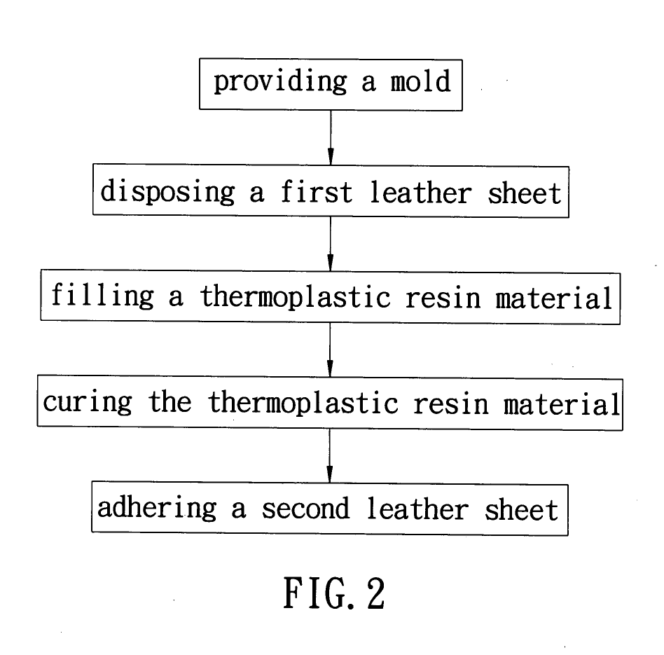

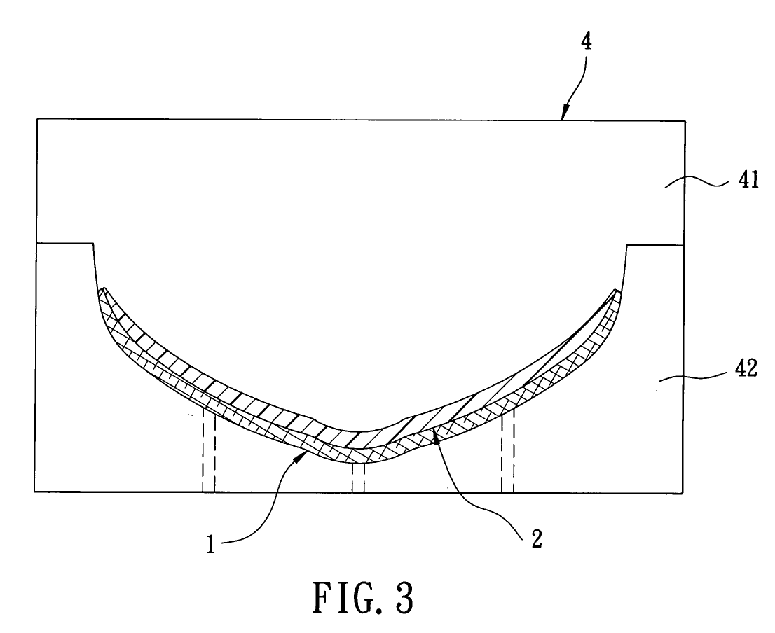

FIGS. 2 and 3 illustrate the method for producing the seat pad shown in FIG. 1. The method includes the steps of: providing a mold 4 having a mold cavity; disposing a first leather sheet 1 in the mold cavity in the mold 4; filling a thermoplastic resin material, e.g. polyurethane (PU), into the mold cavity; curing the thermoplastic resin material and molding an assembly of the thermoplastic resin material and the first leather sheet 1 so as to form the thermoplastic resin material into a rigid resin layer 2 bonded to the first leather sheet 1; removing the assembly of the rigid resin layer 2 and the first leather sheet 1 from the mold 4; and adhering a second leather sheet 3 to one side of the first leather sheet 1 opposite to the rigid resin layer 2 by an adhesive.

As shown in FIG. 3, the mold 4 used in this method includes male and female mold halves 41, 42, which cooperatively define the mold cavity. The first leather sheet 1 is disposed in the female mold half 42. The male mold half 41 cooperates with the first leather sheet 1 to define a gap therebetween when the male and female mold halves 41, 42 are closed. Formation of the rigid resin layer 2 is conducted by filling the thermoplastic resin material into the gap.

According to the present invention, since connection between the rigid resin layer 2 and the first leather sheet 1 is achieved by curing the thermoplastic resin material in the mold 4, the connection strength therebetween is improved and the desired shape is easily obtained. The complicated process for connecting the leather sheets and the resilient support unit as required in the prior art can be eliminated. Moreover, the second leather sheet 3 with a superior quality over the first leather sheet 1 serves as the outermost layer of the seat pad, while the first leather sheet 1 with an inferior quality is covered by the second leather sheet 3. As such, the seat pad of this invention has good appearance while minimizing costs.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for making a seat pad, comprising the steps of:
providing a mold having a mold cavity;
disposing a first leather sheet in the mold cavity in the mold;
filling a thermoplastic resin material into the mold cavity;
curing the thermoplastic resin material and molding an assembly of the thermoplastic resin material and the first leather sheet so as to form the thermoplastic resin material into a rigid resin layer bonded to the first leather sheet;
removing the assembly of the rigid resin layer and the first leather sheet from the mold; and
adhering a second leather sheet to one side of the first leather sheet opposite to the rigid resin layer.

2. The method of claim 1, wherein the thermoplastic resin material is polyurethane.

3. The method of claim 1, wherein the mold includes male and female mold halves which cooperatively define the mold cavity, the first leather sheet being disposed in the female mold half, the male mold half cooperating with the first leather sheet to define a gap therebetween when the male and female mold halves are closed, formation of the rigid resin layer being conducted by filling the thermoplastic resin material into the gap.

4. A seat pad comprising:
a first leather sheet having upper and lower surfaces;
a second leather sheet adhered to said upper surface of said first leather sheet; and
a rigid resin layer of a thermoplastic material bonded to said lower surface of said first leather sheet.

5. The seat pad of claim 4, wherein said rigid resin layer of thermoplastic material is made from polyurethane.
